(19) United States
(12) Patent Application Publication
(10) Pub. No.: US 2009/0316051 A1
(43) Pub. Date: Dec. 24, 2009

(54) MOVING PICTURE DISTRIBUTION APPARATUS

(75) Inventor: Hidenobu MIYOSHI, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/548,519

(22) Filed: Aug. 27, 2009

Related U.S. Application Data
(63) Continuation of application No. PCT/JP2007/000231, filed on Mar. 15, 2007.

(51) Int. Cl. H04N 5/38

(52) U.S. Cl. 348/723; 348/E05.093

(57) ABSTRACT

To provide a moving picture distribution apparatus for realizing the distribution of moving pictures whose main contents cannot be viewed without viewing a CM, the moving picture distribution apparatus (100) includes a first moving picture information acquisition device (101) for acquiring moving picture data having first moving picture coded data and a first moving picture reproduction parameter, a second moving picture reproduction parameter acquisition device (102) for acquiring a second moving picture reproduction parameter, a transmission data generation device (103) for generating combined transmission data by combining the moving picture data with the second moving picture reproduction parameter, and a moving pictures transmission device (104) for transmitting the combined transmission data to a receiver.

### CROSS-REFERENCE TO RELATED APPLICATION

This application is a continuation of PCT application of PCT/JP2007/000231, which was filed on Mar. 15, 2007.

### FIELD

The present invention relates to a moving picture distribution apparatus for distributing moving pictures.

### BACKGROUND

In a conventional terrestrial broadcast, it is common to provide an moving picture distribution service with advertising revenues by inserting an advertisement (hereinafter referred to simply as a CM (commercial message) into main contents such as movies, dramas, etc. In addition, by the recent combination of broadcasts and communications, the moving picture distribution services with advertising revenues have become widespread using networks such as the Internet etc.

On the other hand, a picture recording device for recording distributed moving pictures has been provided with various convenient functions, and a picture recording device having the function of easily cutting out only CMs from moving pictures has been widely used. Therefore, there is an increasing number of viewers enjoying only the main contents without viewing CMs.

In the moving picture distribution service with advertising revenues, the server obtains an advertising fee (revenue) from the advertiser by distributing CMs. The advertising fee is the source of the finance for producing moving pictures. Therefore, there is the problem that the service does not hold if the viewers do not view the CMs.

As the technology for solving the above-mentioned problem, the patent document 1 discloses a contents reproduction device for reproducing contents while decoding scrambled contents processed by encryption etc. The device has a mechanism of concurrently reproducing contents and CMs, and continuously and alternately reproduces the main contents and the CMs.

The patent document 2 discloses a device for managing the copyright of streaming media using the mechanism of managing objects of contents and copyright.

However, for example, as with the patent document 1, when the moving picture transmission device encrypts the main contents, the reproduction device requires a special device for decrypting the encryption by extracting a decoding key from CMs.

Patent Document 1: Japanese Laid-open Patent Publication No. 2003-333566

Patent Document 2: Japanese Laid-open Patent Publication No. 2005-513664

### SUMMARY

The present invention has been developed to solve the above-mentioned problem, and the problem to be solved is to provide a moving picture distribution apparatus for easily realizing a moving picture distribution not allowing a receiver to view main contents without viewing CMs.

To solve the above-mentioned problem, the moving picture distribution apparatus according to the present invention can independently distribute moving picture coded data obtained by coding any moving picture information and a necessary moving picture reproduction parameter for reproducing the moving picture coded data, and includes: a first moving picture information acquisition device for acquiring moving picture data configured by first moving picture coded data obtained by coding first moving picture information, and a first moving picture reproduction parameter necessary for reproducing the first moving picture coded data; a second moving picture reproduction parameter acquisition device for acquiring second moving picture reproduction parameter necessary for reproducing second moving picture coded data obtained by coding second moving picture information; a transmission data generation device for generating combined transmission data by combining the moving picture data with the second moving picture reproduction parameter; and a moving pictures transmission device for transmitting the combined transmission data to the receiver of the second moving picture information.

According to the present invention, the transmission data generation device generates combined transmission data by combining the moving picture data configured by the first moving picture coded data obtained by coding the first moving picture information and the first moving picture reproduction parameter necessary for reproducing the first moving picture coded data with the second moving picture reproduction parameter necessary for reproducing the second moving picture coded data obtained by coding the second moving picture information. The moving pictures transmission device transmits combined transmission data.

Therefore, to reproduce the second moving picture information, that is, the second moving picture coded data, it is necessary to receive the combined transmission data and acquire the second moving picture reproduction parameter. As a result, the moving picture distribution can be realized with the second moving picture information reproduced (viewed) only when the first moving picture information is reproduced (viewed).

As described above, the present invention can provide a moving picture distribution apparatus for easily realizing a moving picture distribution with the main contents viewed only when CMs are viewed.

### BRIEF DESCRIPTION OF DRAWINGS

FIG. 1 is an explanatory view of the principle of the operation of the moving picture distribution apparatus according to an embodiment of the present invention;

FIG. 2 is an example of the configuration of the moving picture distribution apparatus according to an embodiment of the present invention;

FIG. 3 illustrates the relationship between the moving picture coded data and the moving picture reproduction parameter according to an embodiment of the present invention;

FIG. 4 illustrates the outline of the bit stream according to an embodiment of the present invention;

FIG. 5 is an example of a practical configuration of the SPS, the PPS, and the moving picture coded data according to an embodiment of the present invention;

FIG. 6 is an example of the bit stream according to an embodiment of the present invention;

FIG. 7 is an example of a management table of the main contents coded data according to an embodiment of the present invention;

FIG. 8 is an example of the configuration of the main contents coded data according to an embodiment of the present invention;

FIG. 9 is an example of a management table of the main contents reproduction parameter according to an embodiment of the present invention;

FIG. 10 is an example of the configuration of the main contents reproduction parameter according to an embodiment of the present invention;

FIG. 11 is an example of the management table of the CM stream according to an embodiment of the present invention;

FIG. 12 is an example of the configuration of the CM stream according to an embodiment of the present invention;

FIG. 13 illustrates the outline of the process of generating a combined CM stream according to an embodiment of the present invention;

FIG. 14 is a flowchart of the distributing process of the moving picture distribution apparatus according to an embodiment of the present invention;

FIG. 15 is a flowchart of the reproducing process of the moving pictures reproduction device according to an embodiment of the present invention;

FIG. 16 illustrates the outline of the reproducing process in FIG. 15; and

FIG. 17 illustrates the outline of the reproducing process in FIG. 15.

### DESCRIPTION OF EMBODIMENTS

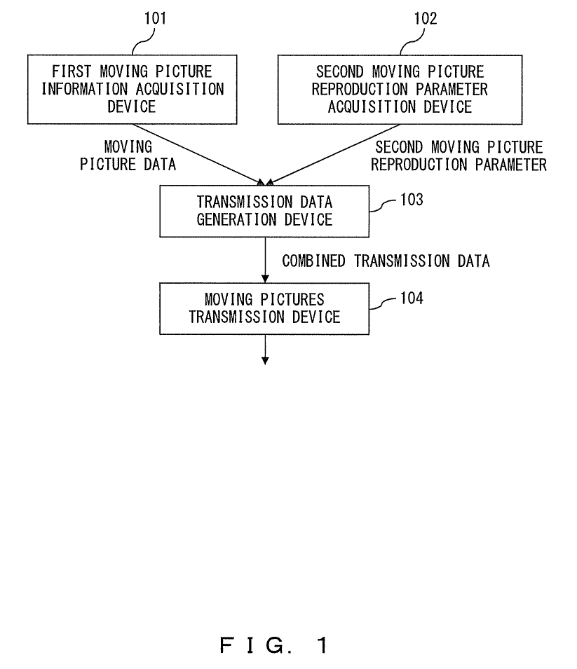

The embodiments of the present invention are described below with reference to FIGS. 1 through 17.

FIG. 1 is an explanatory view of the principle of the operation of the moving picture distribution apparatus 100 according to an embodiment of the present invention.

As illustrated in FIG. 1, a moving picture distribution apparatus 100 includes: a first moving picture information acquisition device 101 for acquiring moving picture data configured by first moving picture coded data and a first moving picture reproduction parameter; a second moving picture reproduction parameter acquisition device 102 for acquiring a second moving picture reproduction parameter; a transmission data generation device 103 for generating combined transmission data by combining the moving picture data with the second moving picture reproduction parameter. and a moving pictures transmission device 104 for transmitting the combined transmission data to a receiver.

The moving picture distribution apparatus 100 transmits moving picture coded data obtained by coding any moving picture information such as movies, dramas, CMs and a necessary moving picture reproduction parameter for the moving picture coded data independently and separately, or as one pieces of moving picture data to a receiver.

The first moving picture coded data is obtained by coding the first moving picture information. The first moving picture reproduction parameter is necessary for reproducing the first moving picture coded data. Similarly, the second moving picture coded data is obtained by coding the second moving picture information, and the second moving picture reproduction parameter is necessary for reproducing the second moving picture coded data.

The first moving picture information acquisition device 101 acquires, for example, the moving picture data about the first moving picture information from the first moving picture information storage device storing the moving picture data about the first moving picture information.

The second moving picture reproduction parameter acquisition device 102 acquires, for example, the second moving picture reproduction parameter from the second moving picture information storage device (or second moving picture reproduction parameter storage device) storing the moving picture data (or the second moving picture reproduction parameter) about the second moving picture information.

The first moving picture information is the information always required when the second moving picture information is viewed, for example, the contents such as a CM, etc. (hereinafter referred to simply as “CM contents”). The second moving picture information is contents such as movies, dramas, etc. (hereinafter referred to as “main contents”).

The transmission data generation device 103 generates combined transmission data by combining the moving picture data bout the first moving picture information acquired by the first moving picture information acquisition device 101 with the second moving picture reproduction parameter acquired by the second moving picture reproduction parameter acquisition device 102.

The moving pictures transmission device 104 transmits the combined transmission data generated by the transmission data generation device 103 to the receiver of the second moving picture information. Although not illustrated in the attached drawings, the moving pictures transmission device 104 transmits the second moving picture coded data to the receiver of the second moving picture information when the transmission of the combined transmission data is completed.

When the second moving picture information is viewed, the second moving picture coded data and the second moving picture reproduction parameter are required. Therefore, it is necessary for a viewer to acquire the second moving picture reproduction parameter from the combined transmission data transmitted precedently. Therefore, it is possible to have the second moving picture information viewed only after the first moving picture information is viewed.

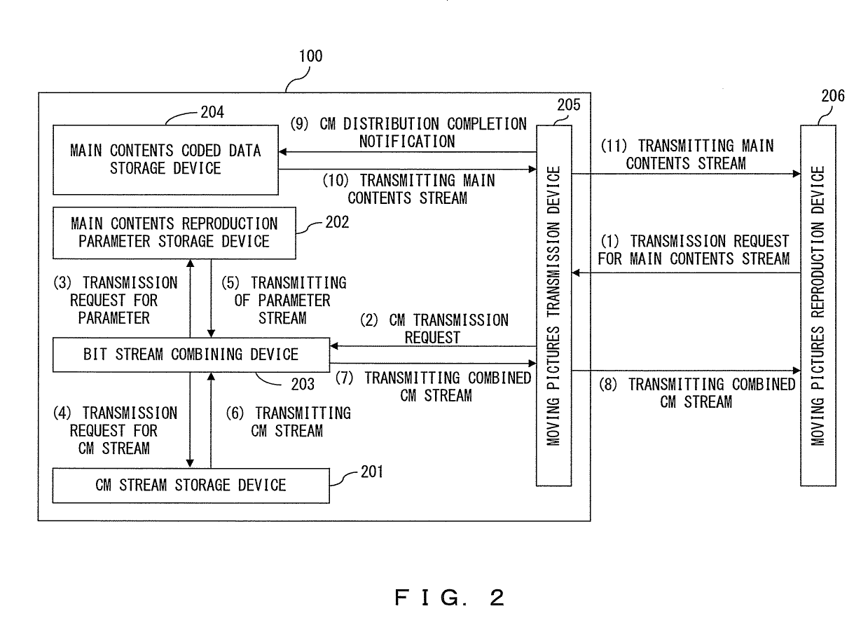

FIG. 2 is an example of the configuration of the moving picture distribution apparatus 100 according to an embodiment of the present invention.

The moving picture distribution apparatus 100 illustrated in FIG. 2 includes: a CM stream storage device 201 storing a CM stream; a main contents reproduction parameter storage device 202 storing a main contents reproduction parameter; a bit stream combining device 203 for generating a combined CM stream by combining a CM stream with a main contents reproduction parameter; a main contents coded data storage device 204 storing the main contents coded data; and a moving pictures transmission device 205 for transmitting the CM stream and the main contents stream to a receiver.

The CM stream storage device 201, the main contents reproduction parameter storage device 202, the bit stream combining device 203, the main contents coded data storage device 204, and the moving pictures transmission device 205 configuring the moving picture distribution apparatus 100 can be devices independent of one another. That is, the components can be interconnected for communications over a network or via dedicated line.

The moving picture distribution apparatus 100 is connected to a moving pictures reproduction device as a receiver over a network etc. Although it is connected over a network etc. in the present embodiment, it can be connected by cable or wireless as far as a signal can be received or transmitted electrically or magnetically. In addition, a signal can be one-way transmitted from the moving picture distribution apparatus 100 to a receiver.

The main contents coded data is obtained by coding the main contents such as movies, dramas, etc. For example, the data can be configured by one or more main contents coded data 0, 1, . . . . A main contents reproduction parameter is necessary in reproducing entire or a part of the main contents coded data. For example, it is configured by a main contents entire-reproduction parameters (SPS described later) 0, 1, . . . and a main contents partial-reproduction parameters (PPS described later) 0, 1, . . . .

The CM stream according to the present embodiment is configured by CM contents coded data obtained by coding CM contents to be inserted before, after or between the main contents, and a CM contents reproduction parameter necessary in reproducing CM contents coded data.

The CM contents coded data is configured by, for example, one or more pieces of CM contents coded data 0, 1, . . . . The CM contents reproduction parameter is configured by, for example, a CM contents entire-reproduction parameter (SPS described later) 0, 1, . . . and a CM contents partial-reproduction parameter (PPS described later) 0, 1, . . . .

The bit stream combining device 203 generates a combined CM stream by dividing, for example, the main contents entire-reproduction parameters 0, 1, . . . and the main contents partial-reproduction parameters 0, 1, . . . and combining the divided parameters with CM streams (for example, inserting them before, after, or between the CM contents entire-reproduction parameters 0, 1, and CM contents partial-reproduction parameters 0, 1, . . . ).

In the present embodiment, the main contents reproduction parameter is divided and combined with (inserted into) the CM stream (especially the CM contents reproduction parameter), but it is obvious that the combination can be performed to create arrangement in accordance with a predetermined rule as necessary.

When the moving picture distribution apparatus 100 (1) receives a transmission request for main contents from the moving pictures reproduction device 206, (2) the moving pictures transmission device 205 requests the bit stream combining device 203 for a CM. Then, (3) the bit stream combining device 203 issues a transmission request to the main contents reproduction parameter storage device 202, and (4) issues a transmission request for CM streams to the CM stream storage device 201. (5) The main contents reproduction parameter storage device 202 transmits a main contents reproduction parameter to the bit stream combining device 203, and (6) the CM stream storage device 201 transmits the CM stream to the bit stream combining device 203.

Upon receipt of the main contents reproduction parameter and the CM stream, the bit stream combining device 203 (7) divides and inserts the main contents reproduction parameter into the CM stream, and generates a combined CM stream. Then, it transmits the combined CM stream to the moving pictures transmission device 205.

Upon receipt of the combined CM stream, (8) the moving pictures transmission device 205 transmits the combined CM stream to the moving pictures reproduction device 206, and (9) notifies the main contents coded data storage device 204 of the completion of the transmission of the combined CM stream (requests the main contents coded data).

At the request of the 205, the main contents coded data storage device 204 reads predetermined main contents coded data and transmits the data (referred to as a “main contents stream”).

Upon receipt of the main contents stream, (11) the moving pictures transmission device 205 transmits the main contents stream to the moving pictures reproduction device 206.

With the above-mentioned configuration, the first moving picture information, the first moving picture coded data, and the first moving picture reproduction parameter respectively correspond to the CM contents, the CM contents coded data, and the CM contents reproduction parameter.

The second moving picture information, the second moving picture coded data, and the second moving picture reproduction parameter respectively correspond to the main contents, the main contents coded data, and the main contents reproduction parameter. The combined transmission data corresponds to the combined CM stream.

The first moving picture information acquisition device 101, the second moving picture reproduction parameter acquisition device 102, and the transmission data generation device 103 are realized by the bit stream combining device 203. The moving pictures transmission device 104 is realized by the moving pictures transmission device 205.

The practical process of the moving picture distribution apparatus 100 according to the present embodiment is described below.

The moving picture coded data (main contents coded data, CM contents coded data) and the moving picture reproduction parameter (main contents reproduction parameter, CM contents reproduction parameter) can be processed completely and separately from each other and are generated in the moving picture coding system.

The present embodiment is described with reference to the case where an H.264/MPEG-4AVC (hereinafter referred to as an “H.264”) is used as the above-mentioned moving picture coding system.

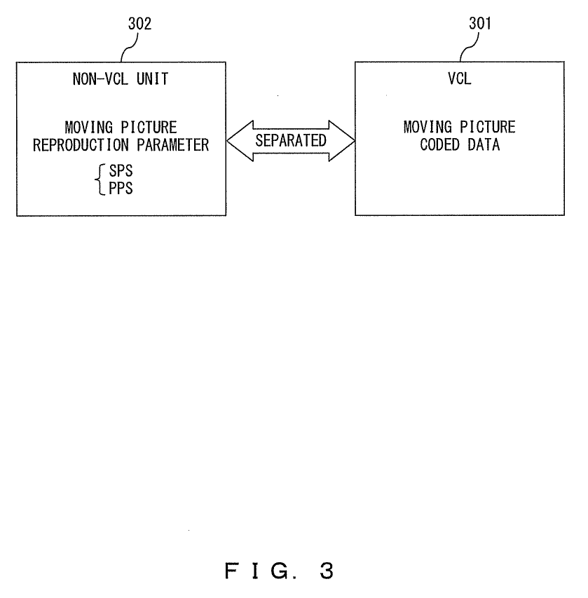

FIG. 3 illustrates the relationship between the moving picture coded data and the moving picture reproduction parameter according to an embodiment of the present invention.

Regulated in the H.264 are a VCL (video coding layer) for performing the moving picture coding process, and a NAL (network abstraction layer) through which the coded information is transmitted and stored with respect to the lower system. The data generated by the VCL can be processed by the NAL by completely separating the data into a VCL unit 301 and a non-VCL unit 302.

The moving picture coded data (main contents coded data, CM contents coded data) according to the present embodiment is configured by a VCL NAL unit. The moving picture reproduction parameter (main contents reproduction parameter, CM contents reproduction parameter) according to the present embodiment is configured by a non VCL NAL unit.

The moving picture reproduction parameter according to the present embodiment is configured by SPS (sequence parameter set) 0, 1, . . . and a PPS (picture parameter set) 0, 1, . . . .

The SPS is a necessary parameter (main contents entire-reproduction parameter, CM contents entire-reproduction parameter) in reproducing entire of the main contents coded data and the CM contents coded data. The PPS is a necessary parameter (main contents partial-reproduction parameter, CM contents partial-reproduction parameter) in reproducing part of the main contents coded data or the CM contents coded data.

As described above, the moving picture reproduction parameter is to be transmitted to the reproduction device before the moving picture coded data which refers to the moving picture reproduction parameter, and the moving picture reproduction parameter and the moving picture coded data can be separately distributed. That is, the moving picture coded data cannot be decoded and reproduced without the moving picture reproduction parameter.

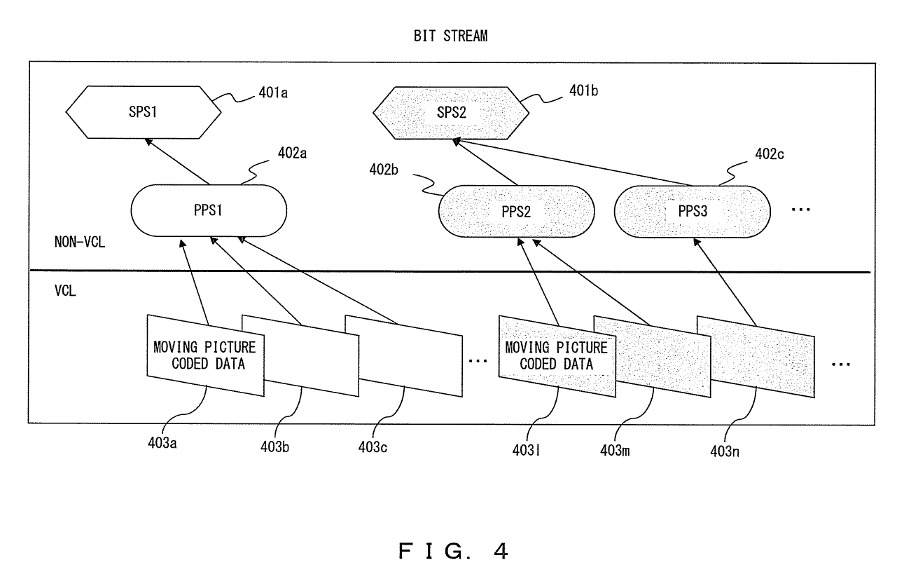

FIG. 4 illustrates the outline of the bit stream according to an embodiment of the present invention.

In the H.264, a plurality of sequences can be processed in one bit stream. FIG. 4 illustrates the concept of configuring one bit stream by sequences 1 and 2.

An SPS 401a is assigned an SPS number (for example, an SPS 1) for identification of a sequence. By specifying the SPS number in a PPS 402a, it is possible to identify to which sequence the PPS belongs. The PPS 402a is also assigned a PPS number (for example, a PPS 1) as an identification number. By specifying the PPS number at the header portion of moving picture coded data 403a, 403b, . . . , it is possible to identify to which sequence each of the moving picture coded data 403a, 403b, . . . belongs.

Similarly, an SPS 401b is assigned an SPS number (for example, an SPS 2) for identification of a sequence, and can identify to which sequence each PPS belongs by specifying the SPS number in the PPS 402b and 402c. In addition, PPS 402b and 402c are assigned PPS numbers (for example, a PPS 2 and a PPS 3 as identification numbers, and the PPS number can be specified at the header portion of the moving picture coded data 403l, 403m, . . . . Therefore, it is possible to identify to which sequence each of the moving picture coded data 403l, 403m, . . . belongs.

As described above, the SPS, the PPS, and the moving picture coded data have a hierarchical structure.

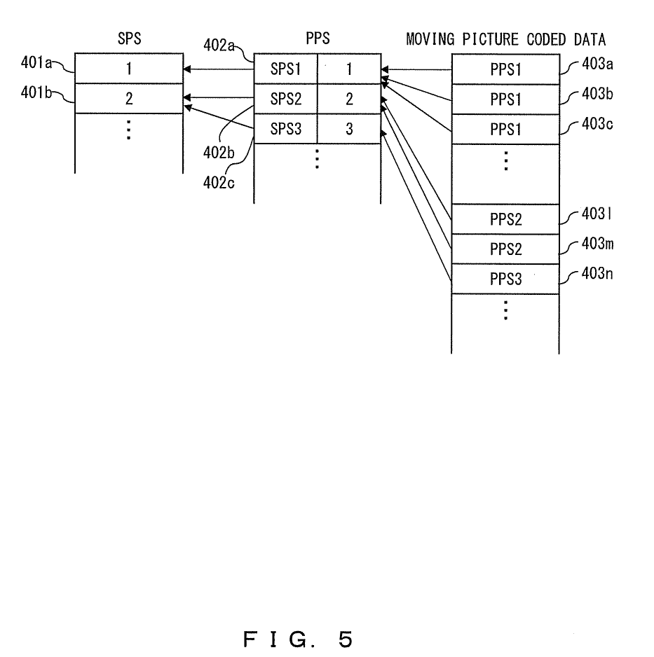

FIG. 5 is an example of a practical configuration of the SPS, the PPS, and the moving picture coded data according to an embodiment of the present invention.

As illustrated in FIG. 4, the SPS 401a and 401b are respectively assigned SPS numbers 1 and 2.

The PPS 402a, 402b, and 402c are assigned the SPS numbers of the respective sequences to which they belong. For example, the PPS 402a is assigned the SPS number 1 because it belongs to the sequence of SPS 1. Similarly, the PPS 402b is assigned the SPS number 2 because it belongs to the sequence of the SPS 2. In addition, the PPS 402a, 402b, and 402c are respectively assigned the identification numbers 1, 2, and 3.

The moving picture coded data 403a, 403b, 402c, . . . , 403l, 403m, 403n, . . . are assigned the PPS numbers of the sequences to which the data belong.

As described above, the SPS, the PPS, and the moving picture coded data according to the present embodiment have a hierarchical structure on which the PPS can be referred to from the moving picture coded data and the SPS can be referred to from the PPS.

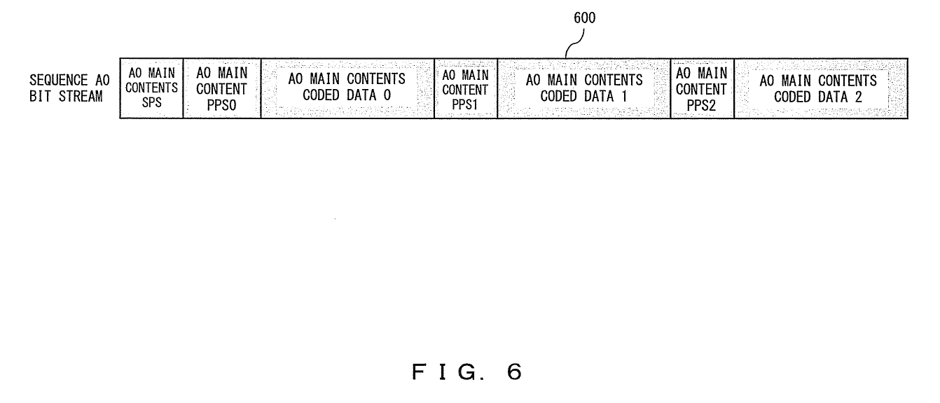

FIG. 6 is an example of the bit stream according to an embodiment of the present invention.

A bit stream 600 illustrated in FIG. 6 is an example of the configuration of the bit stream of the sequence A0 when the main content A is divided into sequences A0 and A1 and coded. The bit stream 600 illustrated in FIG. 6 is configured by the SPS of the sequence number A0 (hereinafter referred to as an “A0 main content SPS”), the PPS 0, 1, and 2 of the sequence number A0 (hereinafter referred to as “A0 main contents PPS 0, 1, and 2”), and the CM contents coded data 0, 1, and 2 of the sequence number A0 (hereinafter referred to as “A0 main content PPS and A0 main contents coded data 0, 1, and 2”). The number of the A0 main contents PPS and the A0 main contents coded data is not limited.

The A0 main contents SPS are referred to from the A0 main content PPS 0, the A0 main content PPS 1, and the A0 main content PPS 2. The A0 main contents PPS 0, the A0 main content PPS 1, and the A0 main content PPS 2 are respectively referred to by the A0 main contents coded data 0, the A0 main contents coded data 1, and the A0 main contents coded data 2.

The above-mentioned main contents coded data is stored in the main contents coded data storage device 204. In the main contents coded data storage device 204, plural pieces of main contents coded data are managed by sequence number.

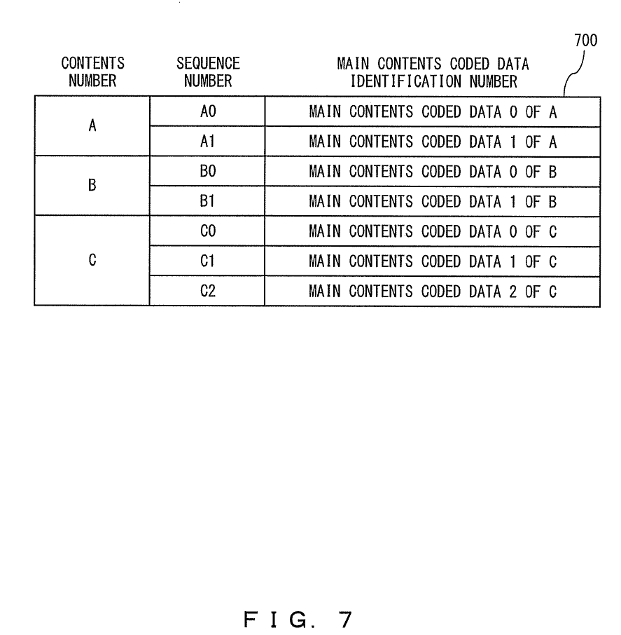

FIG. 7 is an example of a management table 700 of the main contents coded data according to an embodiment of the present invention.

A management table 700 is configured by a contents number, a sequence number, and an identification number of moving picture coded data. For example, the main contents of the contents A are divided into two sequences of the sequence numbers A0 and A1. The sequence numbers A0 and A1 are respectively assigned the main contents coded data 0 and 1. The same holds true with the sequence numbers B and C.

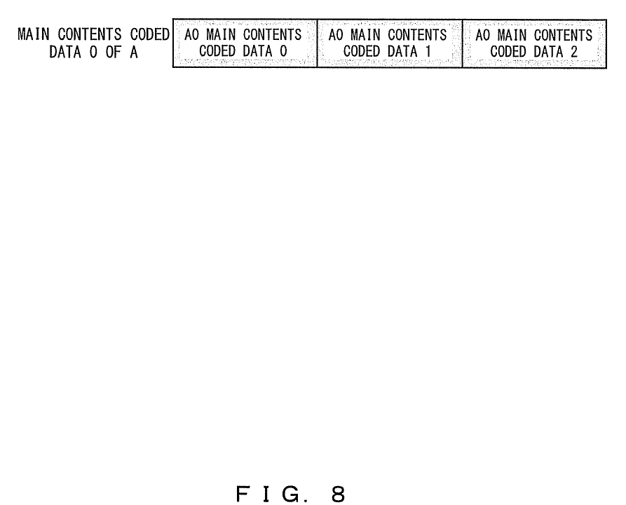

For example, the main contents coded data 0 of A is configured by the A0 main contents coded data 0, 1, and 2. FIG. 8 is an example of the configuration of the main contents coded data 0 of A. As illustrated in FIG. 8, the main contents coded data 0 of A is continuous data of the A0 main contents coded data 0, the A0 main contents coded data 1, and the A0 main contents coded data 2. The number of pieces of the A0 main contents coded data is not limited.

The main contents reproduction parameter is stored in the main contents reproduction parameter storage device 202. The main contents reproduction parameter storage device 202 manages a plurality of main contents reproduction parameters by sequence number as with the main contents coded data storage device 204.

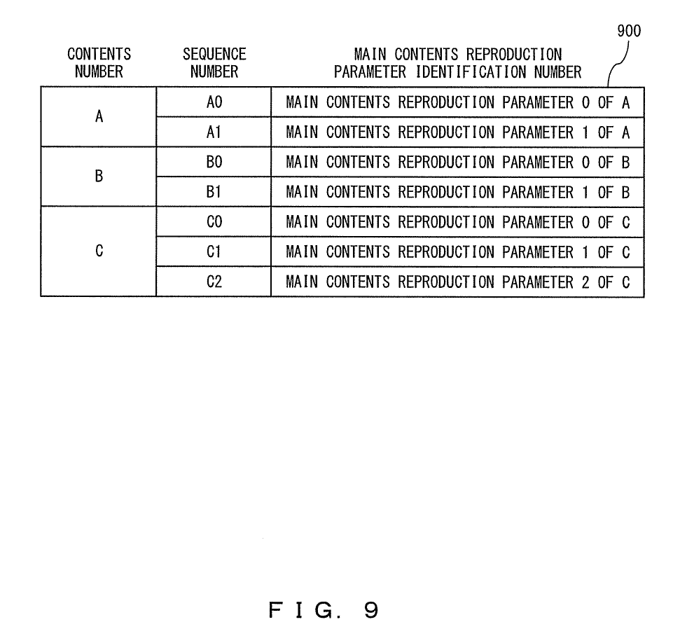

FIG. 9 is an example of a management table 900 of the main contents reproduction parameter according to an embodiment of the present invention.

The management table 900 illustrated in FIG. 9 is configured by a contents number, a sequence number, and an identification number of a moving picture reproduction parameter. For example, the main contents of the contents A are divided into two sequences of the sequence numbers A0 and A1. The sequence numbers A0 and A1 are respectively assigned the main contents reproduction parameters 0 and 1. The same holds true with the sequence numbers B and C.

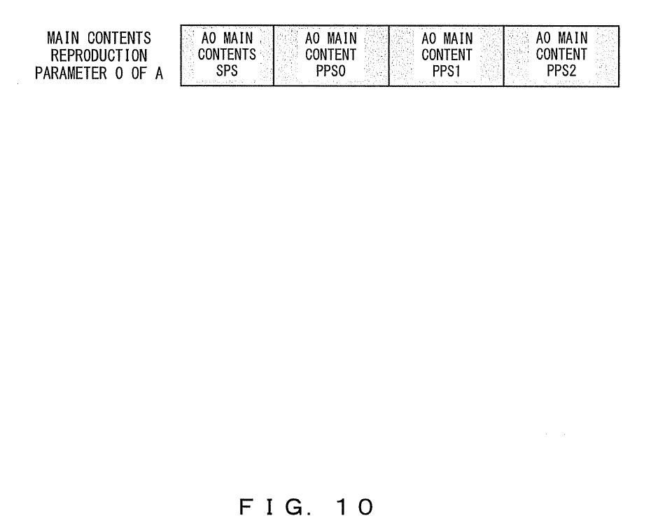

For example, the main contents reproduction parameter 0 of A is configured by the A0 main contents SPS, the A0 main content PPS 0, 1, and 2. FIG. 10 is an example of the configuration of the main contents reproduction parameter of A. As illustrated in FIG. 10, the main contents reproduction parameter 0 of A is continuous data of the A0 main contents SPS, the A0 main content PPS 0, the A0 main content PPS 1, and the A0 main content PPS 2.

The CM contents coded data and the CM contents reproduction parameter are stored as one bit stream in the CM stream storage device 201. The CM stream storage device 201 manages a plurality of CM streams by sequence number.

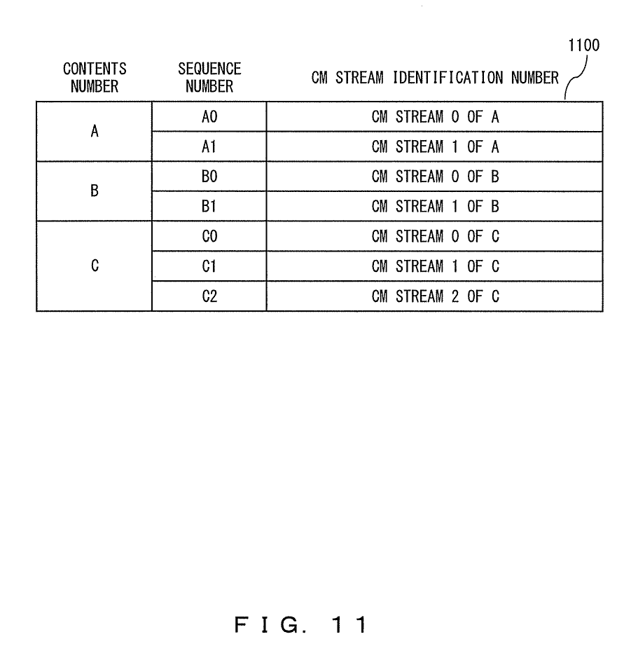

FIG. 11 is an example of the management table 1100 of the CM stream according to an embodiment of the present invention.

The management table 1100 illustrated in FIG. 11 is configured by a contents number, a sequence number, and an identification number of a CM stream. For example, the CM stream of the contents A are divided into two sequences of the sequence numbers A0 and A1. The sequence numbers A0 and A1 are respectively assigned the CM streams 0 and 1. The same holds true with the sequence numbers B and C.

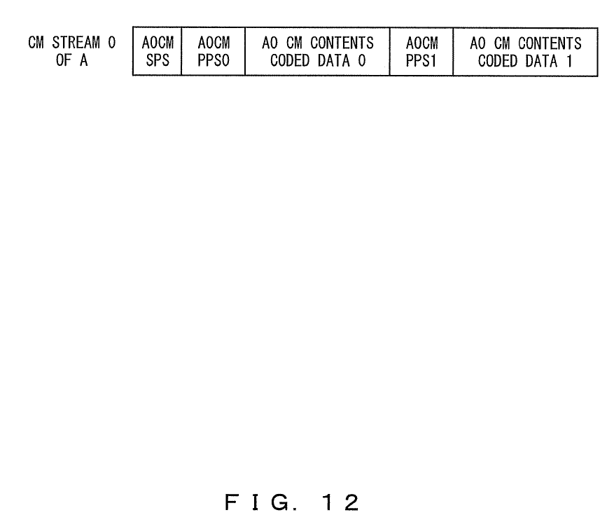

FIG. 12 is an example of the configuration of the CM stream of A. As illustrated in FIG. 12, the CM stream 0 of A is configured by the SPS of the sequence number A0 (hereinafter referred to as an “AOCMSPS”), the PPS 0 and 1 of the sequence number A0 (hereinafter referred to as “AOCMPPS 0 and 1”) and the contents coded data 0 and 1 of the sequence number A0 (hereinafter referred to as “AOCM coded data 0 and 1”). The numbers of AOCMPPS and AOCM coded data are not limited.

The AOCMSPS is referred to from AOCMPPS 0 and 1. The AOCMPPS 0 and the AOCMPPS 1 are referred to from the AOCM coded data 0 and the AOCM coded data 1.

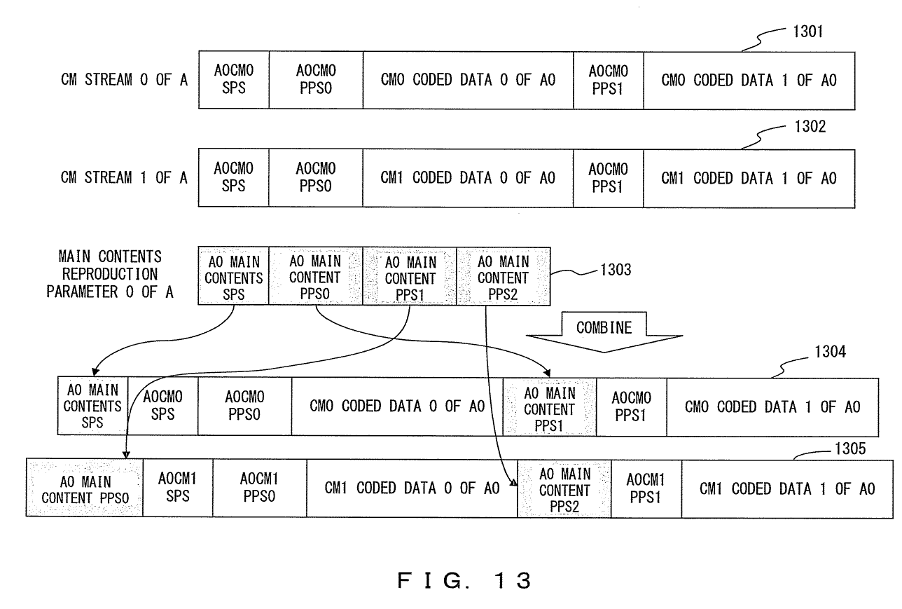

FIG. 13 illustrates the outline of the process of generating a combined CM stream according to an embodiment of the present invention.

In FIG. 13, CM streams 1301 and 1302 of the sequence number A0 about the contents A and a main contents reproduction parameter 1303 are combined to generate combined CM streams 1304 and 1305.

As in FIG. 12, the CM stream 1301 is configured by the AOCMOSPS, the AOCMOPPS 0 and 1, and the AOCM0 coded data 0 and 1, and the CM stream 1302 is configured by the AOCM1SPS, the AOCM1PPS 0 and 1, and the AOCM1 coded data 0 and 1. The main contents reproduction parameter 1303 is similar to the main contents reproduction parameter illustrated in FIG. 10.

When the bit stream combining device 203 acquires the CM streams 1301 and 1302 from the CM stream storage device 201, and the main contents reproduction parameter 1303 from the main contents reproduction parameter storage device 202, the bit stream combining device 203 inserts the reproduction parameter 1303 before the reproduction parameters of the CM streams 1301 and 1302.

For example, the bit stream combining device 203 inserts and combines the A0 main contents SPS, the A0 main content PPS 0, the A0 main content PPS 1, and the A0 main content PPS 2 before each of the moving picture reproduction parameter AOCMOSPS, the AOCMOPPS 1, the AOCM1SPS, and the AOCM1PPS 1 of the CM streams 1301 and 1302.

Thus, the main contents reproduction parameter 1303 can be divided, inserted, and combined in the CM streams 1301 and 1302.

The inserting and combining processes are not limited to the above-mentioned processes. For example, the A0 main contents SPS, the A0 main content PPS 0, A0 main content PPS 1, and the A0 main content PPS 2 can be combined after each of the moving picture reproduction parameter AOCMOSPS, AOCMOPPS 1, AOCM1SPS, and the AOCM1PPS 1 of the CM streams 1301 and 1302, or before (or after) the CM stream 0 coded data 0, the CM stream 0 coded data 1, the CM stream 1 coded data 0, and the CM stream 1 coded data 0. In addition, in accordance with a predetermined rule, the main contents reproduction parameter can be inserted into the CM stream.

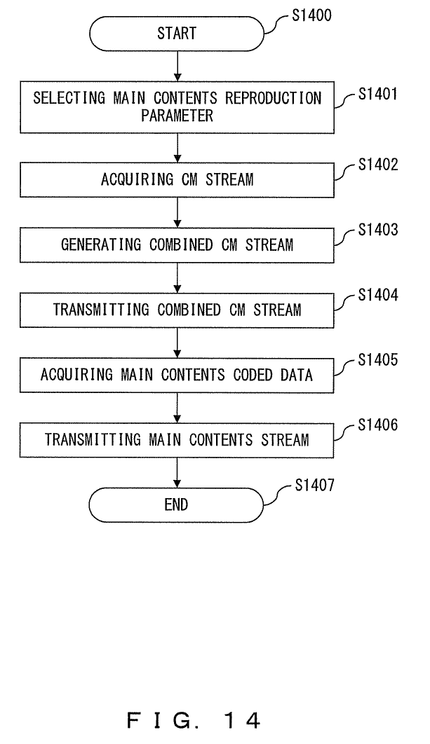

FIG. 14 is a flowchart of the distributing process of the moving picture distribution apparatus 100 according to an embodiment of the present invention.

Upon receipt of a transmission request for the main contents from the moving pictures reproduction device 206, the moving picture distribution apparatus 100 starts the moving picture distributing process (step S1400). The process performed when the main contents of the sequence number A0 is described below.

In step S1401, the moving picture distribution apparatus 100 acquires a necessary parameter in reproducing the main contents of A0 (main contents reproduction parameter). For example, when the moving pictures transmission device 205 outputs a transmission request of the CM of A0 to the bit stream combining device 203, the bit stream combining device 203 outputs, in response to the transmission request of the CM of A0, a transmission request of the main contents reproduction parameter of A0 to the main contents reproduction parameter storage device 202.

Then, the main contents reproduction parameter storage device 202 refers to the management table 900, retrieves a necessary parameter for reproducing the main contents of A0 (main contents reproduction parameter), reads the corresponding main contents reproduction parameter from a predetermined address, and transmits the parameter to the bit stream combining device 203.

In step S1402, the moving picture distribution apparatus 100 acquires the CM stream of A0.

For example, when the bit stream combining device 203 outputs a transmission request of the CM stream of A0 to the CM stream storage device 201, the CM stream storage device 201 refers to, in response to the transmission request of the CM stream of A0, the management table 1100, and retrieves the CM stream to be reproduced when the main contents of A0 are reproduced. Then, the corresponding CM streams 0, 1, . . . are read from a predetermined address, and transmitted to the bit stream combining device 203.

In step S1403, the moving picture distribution apparatus 100 combines the main contents reproduction parameter acquired in step S1401 with the CM stream acquired in step S1402. The practical combining process is described with reference to FIG. 13.

The SPS number and the pps number are different between the CM contents reproduction parameter and the main contents reproduction parameter.

The main contents reproduction parameter is combined with the CM stream transmitted to the moving pictures reproduction device 206 before the transmission of the main contents coded data that refers to the main contents reproduction parameter. Thus, the reference relationship between the main contents reproduction parameter and the main contents coded data is maintained.

In step S1404, the moving picture distribution apparatus 100 transmits the combined CM stream generated in step S1403 to the moving pictures reproduction device 206 that has requested the transmission of the main contents.

For example, the bit stream combining device 203 transmits the combined CM stream of A0 generated in step S1403 to the moving pictures transmission device 205. The moving pictures transmission device 205 distributes the received combined CM stream of A0 to the moving pictures reproduction device 206 that has requested the transmission of the main contents by using of streaming technique.

In step S1405, the moving picture distribution apparatus 100 acquires the main contents coded data of A0. For example, when the moving pictures transmission device 205 distributes all of the combined CM stream of A0, it outputs a CM distribution completion notification/data transmission request of A0 to the main contents coded data storage device 204. Upon receipt of the CM distribution completion notification/data transmission request of A0, the main contents coded data storage device 204 refers to the management table 700, retrieves the main contents coded data of A0, reads the corresponding main contents coded data from a predetermined address, and transmits the data to the moving pictures transmission device 205.

In step S1406, the moving picture distribution apparatus 100 transmits the main contents coded data of A0 acquired in step 1405 to the moving pictures reproduction device 206 that has requested the transmission of the main contents.

The moving pictures transmission device 205 distributes the main contents coded data of A0 received from the main contents coded data storage device 204 to the moving pictures reproduction device 206 that has requested the transmission of the main contents in a streaming manner.

As described above, by dividing, inserting, and combining the main contents reproduction parameter in the CM stream (before and after the SPS, the PPS, and the coded data), the main contents reproduction parameter cannot be acquired without receiving and reproducing all CM streams. That is, without reproducing (viewing) all CM contents, the main contents cannot be reproduced (viewed).

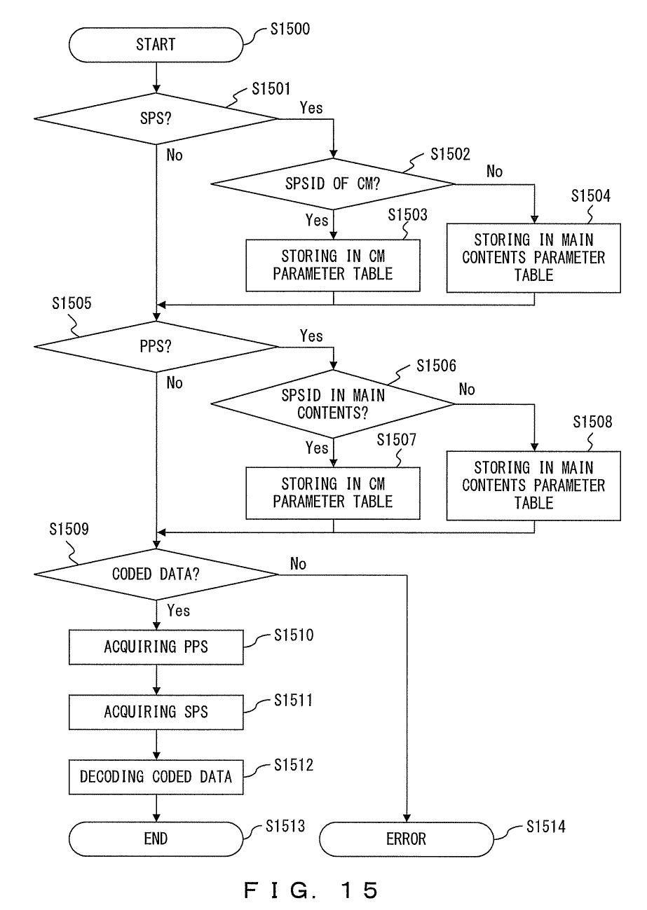

FIG. 15 is a flowchart of the reproducing process of the moving pictures reproduction device 206 according to an embodiment of the present invention. The moving pictures reproduction device 206 performs a reproducing process in accordance with the standard of the H.264. Therefore, the detailed description is omitted here.

FIG. 15 is a flowchart of the reproducing process of the combined CM stream and the main contents stream transmitted by the moving picture distribution apparatus 100 according to the present embodiment. This reproducing process is performed in accordance with the standard of the H.264. Therefore, the detailed description is omitted here.

Upon receipt of the streaming from the moving picture distribution apparatus 100, the moving pictures reproduction device 206 starts the reproducing process (step S1500).

In step S1501, the moving pictures reproduction device 206 refers to the header portion of the NAL unit of the received streaming. When the NAL unit is the SPS, control is passed to step S1502.

In step S1502, the moving pictures reproduction device 206 acquires the SPSID (SPS identification data) of the SPS. Then, it is determined from the SPSID whether or not it is the SPS of the combined CM stream. When the SPSID is the ID of the combined CM stream, the moving pictures reproduction device 206 stores the SPS in the CM contents table after passing control to step S1503. Then, it is used when the subsequent CM contents coded data is reproduced.

When the SPSID is not the ID of the combined CM stream, the moving pictures reproduction device 206 stores the SPS in the main contents table after passing control to step S1504. Then, it is used when the main contents stream received later is reproduced.

In step S1505 as in step S1501, the moving picture distribution apparatus 100 refers to the header portion of the NAL unit of the received streaming. When the NAL unit is the PPS, control is passed to step S1506.

In step S1506, the moving pictures reproduction device 206 acquires the PPSID (PPS identification data). Then, it determines from the PPSID whether or not it is the PPS of the combined CM stream. If the PPSID is the ID of the combined CM stream, the moving pictures reproduction device 206 passes control to step S1507, and stores the PPS in the CM contents table. Then, the PPS is used when the subsequent CM contents coded data is reproduced.

When the PPSID is not the ID of the combined CM stream, the moving pictures reproduction device 206 passes control to step S1508, and stores the PPS in the main contents table. Then, it is used when the main contents stream received later is reproduced.

The SPS and the PPS of the CM contents and the SPS and the PPS of the main contents in the combined CM stream are assigned the respective identifiers (SPSID, PPSID). The SPSID and the PPSID of the CM contents are different from the SPSID and the PPSID of the main contents.

In step S1509 as in step S1501, the moving pictures reproduction device 206 refers to the header portion of the NAL unit of the received streaming. When the NAL unit is moving picture coded data, the moving pictures reproduction device 206 passes control to step S1510.

In step S1510, the moving pictures reproduction device 206 acquires the PPS stored in the processes in steps S1505 through S1508. When the PPS refers to the moving picture coded data of the combined CM stream, the PPS is read from the CM contents table. When the PPS refers to the moving picture coded data of the main contents stream, the PPS is read from the main contents table, and set in a predetermined register.

In step S1511, the moving pictures reproduction device 206 acquires the SPS stored in the processes in steps S1501 through S1504. Also in this case, when the SPS refers to the moving picture coded data of the combined CM stream, it is read from the CM contents table. When the SPS refers to the moving picture coded data of the main contents stream, it is read from the main contents table. The read SPS is set in a predetermined register.

In step S1512, the moving pictures reproduction device 206 decodes and reproduces the moving picture coded data on the basis of the PPS set in step S1510 and the SPS set in step S1511, thereby terminating the reproducing process. In step S1509, when the NAL unit is not the moving picture coded data, the moving pictures reproduction device 206 passes control to step S1514, and abnormally terminates the process.

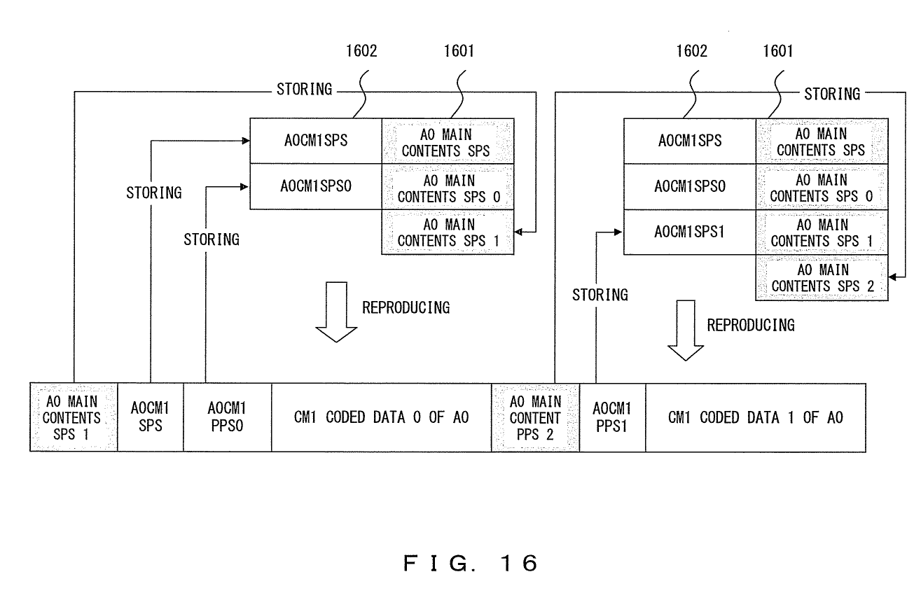

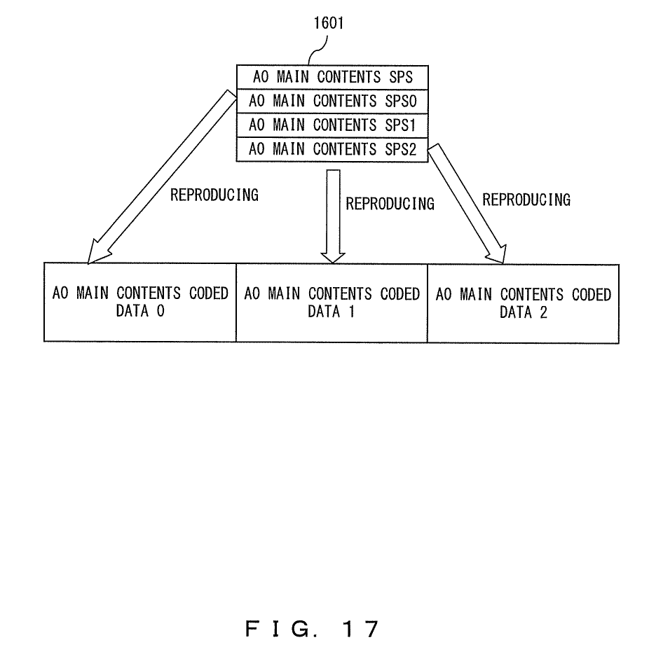

FIGS. 16 and 17 illustrate the outline of the reproducing process in FIG. 15.

The stream illustrated in FIG. 16 is the combined CM stream 1305 illustrated in FIG. 13.

Upon receipt of the 1305, the moving pictures reproduction device 206 reads the PPSID of the leading NAL unit (A0 main content PPS 1). In this case, since the PPSID does not refer to the combined CM stream 1305, the A0 main content PPS 1 is stored in a main contents table 1601.

The moving pictures reproduction device 206 reads the SPSID of the next NAL unit (AOCM1SPS). In this case, since the SPSID refers to the combined CM stream 1305, the AOCM1SPS is stored in a CM contents table 1602. Similarly, the AOCM1PPS0 is stored in the CM contents table 1602.

Since the next NAL unit is moving picture coded data (CM1 moving picture coded data 0 of A0), the AOCM1SPS and the AOCM1PPS0 are read from the CM contents table 1602 to reproduce the CM1 moving picture coded data 0.

The moving pictures reproduction device 206 reads the PPSID of the next NAL unit (A0 main content PPS2). In this case, since the PPSID does not refer to the ID indicated by the combined CM stream 1305, the A0 main content PPS 2 is stored in the main contents table 1601.

The moving pictures reproduction device 206 reads the PPSID of the next NAL unit (AOCM1PPS1). In this case, since the PPSID refers to the ID of the combined CM stream 1305, the AOCM1PPS1 is stored in the CM contents table 1602.

Since the next NAL unit is moving picture coded data (CM1 moving picture coded data of A0), the AOCM1PPS1 is read from the CM contents table 1602 to reproduce the CM1 moving picture coded data 1.

When the above-mentioned processes are performed on the combined CM streams 1304 and 1305, the main contents table 1601 stores the A0 main contents SPS, the A0 main content PPS0, the A0 main content PPS1, and the A0 main content PPS2.

Upon receipt of the main contents stream configured by the A0 main contents coded data 0, 1, and 2 illustrated in FIG. 17, the moving pictures reproduction device 206 reads the A0 main contents SPS, the A0 main content PPS0, the A0 main content PPS1, and the A0 main content PPS2 from the main contents table 1601 to reproduce the main contents stream (A0 main contents coded data 0, 1, and 2).

As described above, since the combined CM stream according to the present embodiment is obtained by only inserting and combining the main contents reproduction parameter in the CM stream, the moving pictures reproduction device 206 can be reproduced in accordance with the standard of the H.264. Therefore, without adding a special process etc. to the moving pictures reproduction device 206, the main contents can be prevented from being reproduced (viewed) unless all CM contents are reproduced (viewed).

In the descriptions above, the CM stream (CM contents coded data, CM contents reproduction parameter), the main contents reproduction parameter, an the main contents coded data are respectively stored in the CM stream storage device 201, the main contents reproduction parameter storage device 202, and the main contents coded data storage device 204, but they can be generated at a request from the bit stream combining device 203 and the moving pictures transmission device 205.

As described above, by inserting and combining the main contents reproduction parameter in the CM stream, the main contents can be prevented from being reproduced (viewed) unless the CM contents are reproduced (viewed).

Since it is not necessary for the moving picture distribution apparatus 100 to encrypt data, the moving picture distribution apparatus 100 can be simply configured. Therefore, the moving picture distribution apparatus 100 according to the present embodiment can be realized at a low cost.

In addition, since it is only necessary to insert and combine the main contents reproduction parameter into the CM stream, and it is not necessary to add a special process or device to the moving pictures reproduction device 206, the moving picture distribution apparatus 100 can arbitrarily determine whether or not the main contents are to be reproduced (viewed) without reproducing (viewing) the CM contents.

What is claimed is:

1. A moving picture distribution apparatus which independently distributes moving picture coded data obtained by coding any moving picture information and a necessary moving picture reproduction parameter for reproducing the moving picture coded data, comprising:
a first moving picture information acquisition device acquiring moving picture data configured by first moving picture coded data obtained by coding first moving picture information, and a first moving picture reproduction parameter necessary for reproducing the first moving picture coded data;
a second moving picture reproduction parameter acquisition device acquiring second moving picture reproduction parameter necessary for reproducing second moving picture coded data obtained by coding second moving picture information;
a transmission data generation device generating transmission data with a parameter by combining the moving picture data with the second moving picture reproduction parameter; and
a moving pictures transmission device transmitting the transmission data with the parameter to a receiver of the second moving picture information.

2. The apparatus according to claim 1, further comprising
a second moving picture coded data acquisition device acquiring second moving picture coded data obtained by coding the second moving picture information, wherein
the moving pictures transmission device transmits the second moving picture coded data after transmitting the transmission data with the parameter.

3. The apparatus according to claim 1, wherein
the transmission data generation device generates transmission data with the parameter by dividing and combining the second moving picture reproduction parameter in the moving picture data.

4. The apparatus according to claim 1, wherein
the moving picture reproduction parameter is a necessary parameter to reproduce the moving picture coded data according to a predetermined rule.

5. The apparatus according to claim 1, wherein
The first and second moving picture reproduction parameters are configured by a necessary parameter to reproduce entire moving picture coded data, and a necessary parameter to reproduce a part of the moving picture coded data.

6. A moving picture distributing method capable of independently distributing moving picture coded data obtained by coding any moving picture information and a necessary moving picture reproduction parameter for reproducing the moving picture coded data, comprising:
a first moving picture information acquiring process of acquiring moving picture data from a first moving picture information storage device for storing the moving picture data configured by first moving picture coded data obtained by coding first moving picture information, and a first moving picture reproduction parameter necessary for reproducing the first moving picture coded data;
a second moving picture reproduction parameter acquiring process of acquiring second moving picture reproduction parameter necessary for reproducing second moving picture coded data obtained by coding second moving picture information;
a transmission data generating process of generating transmission data with a parameter by combining the moving picture data with the second moving picture reproduction parameter; and
a moving pictures transmitting process of transmitting the transmission data with the parameter to a receiver of the second moving picture information.

7. The method according to claim 6, wherein
the second moving picture coded data is transmitted by further performing a second moving picture coded data acquiring process of acquiring the second moving picture coded data from a second moving picture coded data storage device for storing the second moving picture coded data obtained by coding the second moving picture information after transmitting the transmission data with the parameter.

8. The method according to claim 6, wherein
the transmission data generating process generates transmission data with the parameter by dividing and combining the second moving picture reproduction parameter in the moving picture data.

9. The method according to claim 6, wherein
the moving picture reproduction parameter is a necessary parameter to reproduce the moving picture coded data according to a predetermined rule.

10. The method according to claim 6, wherein
the first and second moving picture reproduction parameters are configured by a necessary parameter to reproduce entire moving picture coded data, and a necessary parameter to reproduce a part of the moving picture coded data.

11. A storage medium storing a program used to direct an information processing device to independently distribute moving picture coded data obtained by coding any moving picture information and a necessary moving picture reproduction parameter for reproducing the moving picture coded data, comprising:
a first moving picture information acquiring process of acquiring moving picture data from a first moving picture information storage device for storing the moving picture data configured by first moving picture coded data obtained by coding first moving picture information, and a first moving picture reproduction parameter necessary for reproducing the first moving picture coded data;
a second moving picture reproduction parameter acquiring process of acquiring second moving picture reproduction parameter necessary for reproducing second moving picture coded data obtained by coding second moving picture information;
a transmission data generating process of generating transmission data with a parameter by combining the moving picture data with the second moving picture reproduction parameter; and
a moving pictures transmitting process of transmitting the transmission data with the parameter to a receiver of the second moving picture information.

12. The storage medium storing the program according to claim 11, wherein
the second moving picture coded data is transmitted by further performing a second moving picture coded data acquiring process of acquiring the second moving picture coded data from a second moving picture coded data storage device for storing the second moving picture coded data obtained by coding the second moving picture information after transmitting the transmission data with the parameter.

13. The storage medium storing the program according to claim 11, wherein
the transmission data generating process generates transmission data with a parameter by dividing and combining the second moving picture reproduction parameter in the moving picture data.

14. The storage medium storing the program according to claim 11, wherein
the moving picture reproduction parameter is a necessary parameter to reproduce the moving picture coded data according to a predetermined rule.

15. The storage medium storing the program according to claim 11, wherein
the first and second moving picture reproduction parameters are configured by a necessary parameter to reproduce entire moving picture coded data, and a necessary parameter to reproduce a part of the moving picture coded data.
